(19) United States
(12) Patent Application Publication
(10) Pub. No.: US 2003/0070087 A1
(43) Pub. Date: Apr. 10, 2003

(54) System and method for automatic updating of multiple anti-virus programs

(76) Inventor: Dmitry Gryaznov, Portland, OR (US)

Correspondence Address: SWIDLER BERLIN SHEREFF FRIEDMAN, LLP, 3000 K STREET, NW, BOX IP, WASHINGTON, DC, 20007, US

(21) Appl. No.: 09/970,769

(22) Filed: Oct. 5, 2001

(51) Int. Cl. H04L 9/32

(52) U.S. Cl. 713/201

(57) ABSTRACT

A method, system, and computer program product for automatically updating multiple anti-virus programs without the need to configure and run multiple, different anti-virus program specific updating programs and which avoids the resource and incompatibility issues that running multiple updating programs may create. The method for updating a plurality of anti-virus programs comprises the steps of initiating an update of a plurality of anti-virus programs, determining information to be updated, transferring a plurality of updates, and installing the plurality of updates.

### FIELD OF THE INVENTION

The present invention relates to automatic updating of multiple anti-virus programs.

### BACKGROUND OF THE INVENTION

As the popularity of the Internet has grown, the proliferation of computer malware has become more common. A typical computer malware is a program or piece of code that is loaded onto a computer and/or performs some undesired actions on a computer without the knowledge or consent of the computer operator. One widespread, well-known and dangerous type of computer malware are computer viruses, that is, programs or pieces of code that replicate themselves and load themselves onto other connected computers. Once the virus has been loaded onto the computer, it is activated and may proliferate further and/or damage the computer or other computers.

Along with the proliferation of computer viruses and other malware has come a proliferation of software to detect and remove such viruses and other malware. This software is generically known as anti-virus software or programs. In order to detect a virus or other malicious program, an anti-virus program typically scans files stored on disk in a computer system and/or data that is being transferred or downloaded to a computer system and compares the data being scanned with profiles that identify various kinds of malware. The anti-virus program may then take corrective action, such as notifying a user or administrator of the computer system of the virus, isolating the file or data, deleting the file or data, etc.

As new viruses and other malware are continually being introduced, an anti-virus program must continually be updated with profiles that allow the detection of the new viruses and other malware. Most anti-virus programs include an auto-update feature that enables the program to download profiles of new viruses and other malware. While such auto-update features may work on computer systems that have only one anti-virus program installed, problems can arise in computer systems in which multiple anti-virus programs have been installed. In particular, each anti-virus program typically uses a scheduling and updating program that are different from those used by other anti-virus programs. When multiple anti-virus programs are installed on a single computer system, problems can occur due to limited resources and incompatibility caused by different and incompatible scheduling and updating programs. A need arises for a technique by which multiple anti-virus programs can be automatically updated without the need to configure and run multiple, different anti-virus program specific updating programs and which avoids the resource and incompatibility issues that running multiple updating programs may create.

### SUMMARY OF THE INVENTION

The present invention is a method, system, and computer program product for automatically updating multiple anti-virus programs without the need to configure and run multiple, different anti-virus program specific updating programs and which avoids the resource and incompatibility issues that running multiple updating programs may create.

In one embodiment of the present invention, a method for updating a plurality of anti-virus programs comprises the steps of initiating an update of a plurality of anti-virus programs, determining information to be updated, transferring a plurality of updates, and installing the plurality of updates.

In one aspect of the present invention, the initiating step comprises the step of periodically initiating an update or initiating an update based on at least one predefined condition.

In one aspect of the present invention, the determining step comprises the step of determining information to update based on information relating to the information to be updated and on information relating to the plurality of updates. The information relating to the information to be updated may comprise at least one of a version, a creation date, a modification date, file sizes, and presence or absence of files. The information relating to the plurality of updates may comprise at least one of a version, a creation date, a modification date, file sizes, and presence or absence of files. The information relating to the information to be updated and the information relating to the plurality of updates may comprise script or data files including information indicating the information to be updated and the information relating to the plurality of updates.

In one aspect of the present invention, the transferring step comprises the step of transferring the update using a standard, non-standard, or proprietary protocol. The standard protocol may comprise hypertext transfer protocol or file transfer protocol.

In one aspect of the present invention, the installing step may comprise at least one of decompressing a compressed update, decrypting an encrypted update, and copying a file included in an update to a directory.

In one aspect of the present invention, the method may further comprise the step of logging in to a server containing an update. The logging in step may comprise at least one of transmitting a username and password, filling and submitting an online form, accessing a cookie, and redirecting to another location.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary block diagram of a typical system incorporating the present invention.

FIG. 2 is a block diagram of an exemplary computer system, in which the present invention may be implemented.

FIG. 3 is an exemplary flow diagram of a process of operation of an update control program shown in FIG. 3.

### DETAILED DESCRIPTION OF THE INVENTION

A typical computer malware is a program or piece of code that is loaded onto a computer and/or performs some undesired actions on a computer without the knowledge or consent of the computer operator. Types of malware include computer viruses, Trojan horse programs, and other content. One widespread, well-known and dangerous type of computer malware are computer viruses, that is, programs or pieces of code that replicate themselves and load themselves onto other connected computers. Once the virus has been loaded onto the computer, it is activated and may proliferate further and/or damage the computer or other computers. A particular type of computer virus is the computer worm, which is a program or code that replicates itself over a computer network and may perform malicious actions, such as using up the computer's resources and possibly shutting the system down. A Trojan horse program is typically a destructive program that masquerades as a benign application. Unlike a virus, Trojan horses do not replicate themselves but they can be just as destructive. One insidious type of Trojan horse is a program that claims to rid a computer of malwares but instead introduces malwares onto the computer.

In describing the present invention, the term virus is used for clarity. However, the term virus is used only as an example of malware and the present invention contemplates any and all types of malware.

This software that detects and/or removes malware is generically known as anti-virus software or programs. In order to detect a virus or other malicious program, an anti-virus program typically scans files stored on disk in a computer system and/or data that is being transferred or downloaded to a computer system and compares the data being scanned with profiles that identify various kinds of malware. The anti-virus program may then take corrective action, such as notifying a user or administrator of the computer system of the virus, isolating the file or data, deleting the file or data, etc.

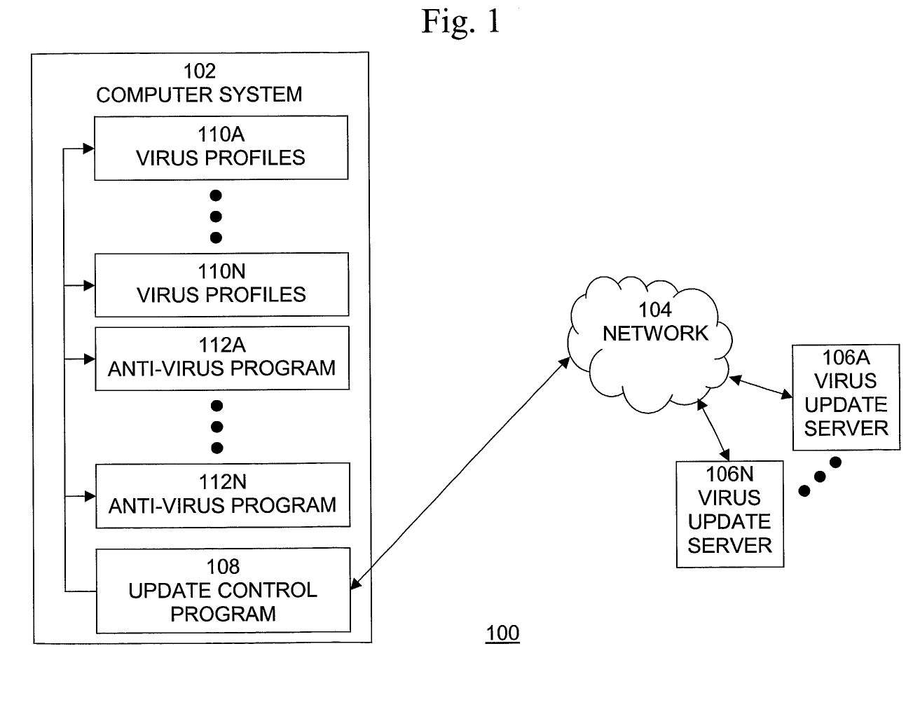

An exemplary block diagram of a typical system 100 incorporating the present invention is shown in FIG. 1. System 100 includes one or more computer systems, such as computer system 102, which are communicatively connected to a data communications network 104, such as a public data communications network, for example, the Internet, or a private data communications network, for example, a private intranet. Computer system 102 generates and transmits requests for information over network 104 to virus update servers, such as virus update servers 106A-N. Servers are computers systems that are communicatively connected to a data communications network, such as network 104, which store and retrieve information and/or perform processing in response to requests received from other systems. The requests for information or processing that are received, for example, by virus update server 106A, are processed and responses, typically including the requested information or results of the processing, are transmitted from virus update server 106A to the requesting computer system. Virus update servers are servers that store virus update information. The virus update information may be the only information stored in a virus update server, or the virus update information may be stored along with any other information in a virus update server. Thus, computer system 102 can communicate with virus update servers, such as virus update server 106A, to request and receive virus update information.

Other computers (not shown), such as user computer systems, servers, etc., may be connected to network 104. Where network 104 is an intranet, computer systems such as user workstations and proprietary servers are typically communicatively connected to network 104. Where network 104 is the Internet, computer systems such as Web servers, Internet service provider servers, and user personal computer systems and workstations are typically communicatively connected to network 104.

Computer system 102 includes update control program 108, a plurality of anti-virus programs, such as anti-virus programs 110A-N, and a plurality of virus profiles, such as virus profiles 112A-N. Update control program 108 communicates with virus update servers 108A-N to access and obtain updates to virus profiles 110A-N and anti-virus programs 112A-N.

Anti-virus programs are software that scans files on disks of computer systems and/or data that is being transferred to computer systems to detect the presence of viruses. Virus profiles are typically data files that include information, such as virus signature patterns, that allow anti-virus programs to detect the presence of viruses in files and transferred data that are being scanned by the anti-virus programs. Each anti-virus program typically uses one or more such virus profiles.

As new viruses are continually being generated, virus profiles 110A-N must continually be updated to include information that will allow the newly generated viruses to be detected. Thus, it is desirable that virus profiles 110A-N be frequently updated, in order to enable detection of newly generated viruses. In addition, the program code of anti-virus programs 112A-N must also be updated, although typically less frequently than virus profiles 110A-N must be updated.

Update control program 108 provides the capability to perform the updating of any and all virus profiles 110A-N and anti-virus programs 112A-N present in computer system 102. Update control program 108 provides the capability to schedule when the updates are to occur, examine configurations to determine what needs to be updated, transfer the update information using a variety of protocols, and unpack the transferred updates to the correct locations.

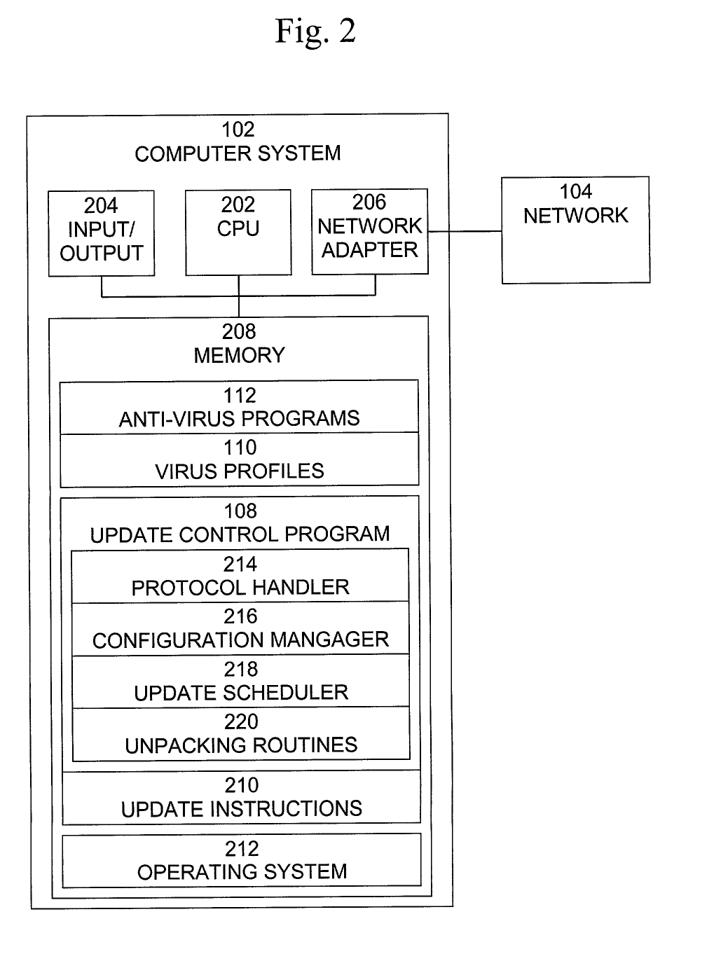

A block diagram of an exemplary computer system 200, in which the present invention may be implemented, is shown in FIG. 2. Computer system 200 is typically a programmed general-purpose computer system, such as a personal computer, workstation, server system, and minicomputer or mainframe computer. Computer system 200 includes processor (CPU) 202, input/output circuitry 204, network adapter 206, and memory 208. CPU 202 executes program instructions in order to carry out the functions of the present invention. Typically, CPU 202 is a microprocessor, such as an INTEL PENTIUM® processor, but may also be a minicomputer or mainframe computer processor. Although in the example shown in FIG. 2, computer system 200 is a single processor computer system, the present invention contemplates implementation on a system or systems that provide multi-processor, multi-tasking, multi-process, multi-thread computing, distributed computing, and/or networked computing, as well as implementation on systems that provide only single processor, single thread computing. Likewise, the present invention also contemplates embodiments that utilize a distributed implementation, in which computer system 200 is implemented on a plurality of networked computer systems, which may be single-processor computer systems, multi-processor computer systems, or a mix thereof.

Input/output circuitry 204 provides the capability to input data to, or output data from, computer system 200. For example, input/output circuitry may include input devices, such as keyboards, mice, touchpads, trackballs, scanners, etc., output devices, such as video adapters, monitors, printers, etc., and input/output devices, such as, modems, etc. Network adapter 206 interfaces computer system 200 with network 104. Network 104 may be any standard local area network (LAN) or wide area network (WAN), such as Ethernet, Token Ring, the Internet, or a private or proprietary LAN/WAN.

Memory 208 stores program instructions that are executed by, and data that are used and processed by, CPU 202 to perform the functions of the present invention. Memory 208 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

Memory 208 includes anti-virus programs 112, virus profiles 110, update control program 108, update instructions 210, and operating system 212. Anti-virus programs are software that scans files on disks of computer systems and/or data that is being transferred to computer systems to detect the presence of viruses. Anti-virus programs 112 may then isolate the files or data that contain the virus, delete the files or data that contain the virus, or, in some cases, remove the virus from the file or data without deleting the entire file or data. Virus profiles are typically data files that include information, such as virus signature patterns, that allow anti-virus programs to detect the presence of viruses in files and transferred data that are being scanned by the anti-virus programs. Each anti-virus program typically uses one or more such virus profiles.

Update control program 108 provides the capability to perform the updating of any and all virus profiles 110 and anti-virus programs 112 present in computer system 102. Update control program 108 includes protocol handler 214, configuration manager 216, update scheduler 218, and unpacking routines 220. Update scheduler 218 provides the capability to schedule when updates are to occur and which virus profiles and/or anti-virus programs are to be updated at any particular time. Configuration manager 216 provides the capability to examine configurations to determine what needs to be updated, for example, by comparing version numbers, creation or modification dates, etc., of update files stored on virus update servers with similar information of virus profiles and anti-virus program files on computer system 102. Protocol handler 214 provides the capability to transfer the update information using a variety of protocols, including standard protocols such as hypertext transfer protocol (HTTP), and file transfer protocol (FTP), etc, and also including any non-standard or proprietary protocols that may be used. Unpacking routines 220 provide the capability to unpack the transferred updates to the correct locations, for example, by decompressing compressed files, decrypting encrypted files, copying files to the proper directories, etc.

Update instructions 210 control the operation of update control program 108. For example, update instructions 210 may specify when updates are to occur and which virus profiles and/or anti-virus programs are to be updated at any particular time, version numbers, creation or modification dates, etc. that are to be used to determine what needs to be updated, protocols that are to be used, locations to which files are to be unpacked, etc. Typically, update instructions 210 are implemented in the form of scripts that are executed by update control program 108. Operating system 212 provides overall system functionality.

Although not shown in FIG. 2, the files and/or data that are scanned, as well as infected files and/or data, may be stored in memory 208, or they may be stored in other computer systems that may be connected via network 210.

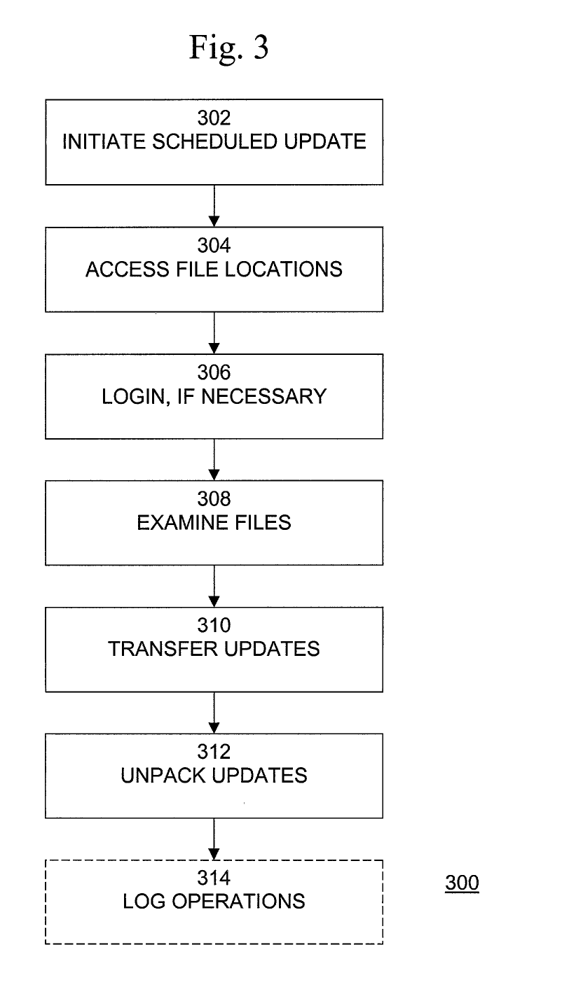

An exemplary flow diagram of a process 300 of operation of update control program 108 is shown in FIG. 3. It is best viewed in conjunction with FIG. 2. Process 300 begins with step 302, in which a scheduled update is initiated. For example, update scheduler 218, may, as directed by update instructions 210, initiate an update of some or all anti-virus programs 112 or virus profiles 110. The update may be scheduled to occur on a periodic basis, such as daily or hourly, the update may be scheduled to occur based on the satisfaction of one or more predefined conditions, or the update may be initiated at the request of the user or administrator of computer system 102.

In step 302, configuration manager 216 accesses the file locations of the updates on one or more virus update servers, as specified in update instructions 210. Update instructions 210 may explicitly specify particular virus update servers to access, or update instructions 210 may implicitly specify virus update servers to access based on specifications of anti-virus programs 112 or virus profiles 110 to be updated. In some cases, it may be necessary to login to a virus update server in order to access the update stored on that server. In such a case, in step 306, configuration manager 216 logs into those virus servers that require logins. Logging in may be a relatively simple process, such as transmitting a username and password, which may be specified in update instructions 210. On the other hand, logging in may be a relatively complex process, requiring the filling and submission of an online form, the accessing of cookies, or redirection to other locations in the virus update server or to other virus update servers. A cookie is information stored in a computer system that is used by a server when the computer system accesses the server. In this situation, the cookie may contain login or security information used by the virus update server. In any case, update instructions 210 specify the appropriate actions to be taken.

In step 308, configuration manager 216 examines configurations to determine what needs to be updated and what files must be transferred from the virus update servers to perform the update. For example configuration manager 216 may access files stored on computer system 102 that make up anti-virus programs 112 and/or virus profiles 110 and may access of update files stored on virus update servers. Configuration manager 216 may then compare version numbers, creation or modification dates, file sizes, presence or absence of files, etc., of update files stored on virus update servers with similar information of virus profiles and anti-virus program files on computer system 102. Likewise, configuration manager 216 may access script or data files on virus update servers that include information indicating what should be updated. In any case, update instructions 210 specify the appropriate actions to be taken.

Depending on the protocol and the update method used by a particular anti-virus update server, it may not be possible to reliably establish the version and the modification date. In this case a file size comparison may be used and if the file on the server is of different size than the one present on the system being updated, the update is initiated. The file on the server can be shorter than the file present on the system being updated, as well as longer—in any case it means it has been modified and the modified version must be obtained. Also, another criterion is simply presence of a file on the virus update server that is not present on the system being updated—in the cases when an update can comprise more than one file. In this case the new file is downloaded.

In step 310, update control program 108 uses protocol handler 214 to transfer the files that must be transferred from the virus update servers to perform the update. Protocol handler 214 may transfer the update information using a variety of protocols, including standard protocols such as hypertext transfer protocol (HTTP), and file transfer protocol (FTP), etc, and also including any other standard, non-standard, or proprietary protocols that may be used. In step 312, unpacking routines 220 unpack the updates from the transferred files. Unpacking routines 220 installs the transferred updates to the correct locations, for example, by unpacking and decompressing compressed files, decrypting encrypted files, copying files to the proper directories, etc. The correct locations may be specified by any suitable mechanism. For example, the correct locations may be specified by update instructions 210, by information included with anti-virus programs and/or virus profiles, by information included with the transferred files, or by information stored on the virus update servers.

Step 314 is an optional step, in which the operations performed by update control program 108 are logged, so as to provide a record of the updates that were performed. Step 314 may not be required in all cases, but may be useful in many cases.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for updating a plurality of anti-virus programs comprising the steps of:
initiating an update of a plurality of anti-virus programs;
determining information to be updated;
transferring a plurality of updates; and
installing the plurality of updates.

2. The method of claim 1, wherein the initiating step comprises the step of:
periodically initiating an update.

3. The method of claim 1, wherein the initiating step comprises the step of:
initiating an update based on at least one predefined condition.

4. The method of claim 1, wherein the determining step comprises the step of:
determining information to update based on information relating to the information to be updated and on information relating to the plurality of updates.

5. The method of claim 4, wherein the information relating to the information to be updated comprises at least one of a version, a creation date, a modification date, file sizes, and presence or absence of files.

6. The method of claim 5, wherein the information relating to the plurality of updates comprises at least one of a version, a creation date, a modification date, file sizes, and presence or absence of files.

7. The method of claim 4, wherein the information relating to the information to be updated and the information relating to the plurality of updates comprises script or data files including information indicating the information to be updated and the information relating to the plurality of updates.

8. The method of claim 1, wherein the transferring step comprises the step of:
transferring the update using a standard, non-standard, or proprietary protocol.

9. The method of claim 8, wherein the standard protocol comprises hypertext transfer protocol or file transfer protocol.

10. The method of claim 1, wherein the installing step comprises at least one of:
decompressing a compressed update, decrypting an encrypted update, and copying a file included in an update to a directory.

11. The method of claim 1, further comprising the step of:
logging in to a server containing an update.

12. The method of claim 11, wherein the logging in step comprises at least one of:
transmitting a username and password, filling and submitting an online form, accessing a cookie, and redirecting to another location.

13. The method of claim 4, wherein the transferring step comprises the step of:
transferring the update using a standard, non-standard, or proprietary protocol.

14. The method of claim 13, wherein the installing step comprises at least one of:
decompressing a compressed update, decrypting an encrypted update, and copying a file included in an update to a directory.

15. The method of claim 14, further comprising the step of:
logging in to a server containing an update.

16. The method of claim 15, wherein the logging in step comprises at least one of:
transmitting a username and password, filling and submitting an online form, accessing a cookie, and redirecting to another location.

17. The method of claim 16, wherein the standard protocol comprises hypertext transfer protocol or file transfer protocol.

18. The method of claim 17, wherein the information relating to the plurality of updates comprises at least one of a version, a creation date, a modification date, file sizes, and presence or absence of files.

19. The method of claim 17, wherein the information relating to the information to be updated and the information relating to the plurality of updates comprises script or data files including information indicating the information to be updated and the information relating to the plurality of updates.

20. The method of claim 17, wherein the initiating step comprises the step of:
periodically initiating an update.

21. The method of claim 17, wherein the initiating step comprises the step of:
initiating an update based on at least one predefined condition.

22. A system for updating a plurality of anti-virus programs comprising:
a processor operable to execute computer program instructions;
a memory operable to store computer program instructions executable by the processor; and
computer program instructions stored in the memory and executable to perform the steps of:
initiating an update of a plurality of anti-virus programs;
determining information to be updated;
transferring a plurality of updates; and
installing the plurality of updates.

23. The system of claim 22, wherein the initiating step comprises the step of:
periodically initiating an update.

24. The system of claim 22, wherein the initiating step comprises the step of:
initiating an update based on at least one predefined condition.

25. The system of claim 22, wherein the determining step comprises the step of:
determining information to update based on information relating to the information to be updated and on information relating to the plurality of updates.

26. The system of claim 25, wherein the information relating to the information to be updated comprises at least one of a version, a creation date, a modification date, file sizes, and presence or absence of files.

27. The system of claim 26, wherein the information relating to the plurality of updates comprises at least one of a version, a creation date, a modification date, file sizes, and presence or absence of files.

28. The system of claim 25, wherein the information relating to the information to be updated and the information relating to the plurality of updates comprises script or data files including information indicating the information to be updated and the information relating to the plurality of updates.

29. The system of claim 22, wherein the transferring step comprises the step of:
transferring the update using a standard, non-standard, or proprietary protocol.

30. The system of claim 29, wherein the standard protocol comprises hypertext transfer protocol or file transfer protocol.

31. The system of claim 22, wherein the installing step comprises at least one of:
decompressing a compressed update, decrypting an encrypted update, and copying a file included in an update to a directory.

32. The system of claim 22, further comprising computer program instructions to perform the step of:
logging in to a server containing an update.

33. The system of claim 32, wherein the logging in step comprises at least one of:
transmitting a username and password, filling and submitting an online form, accessing a cookie, and redirecting to another location.

34. The system of claim 25, wherein the transferring step comprises the step of:
transferring the update using a standard, non-standard, or proprietary protocol.

35. The system of claim 35, wherein the installing step comprises at least one of:
decompressing a compressed update, decrypting an encrypted update, and copying a file included in an update to a directory.

36. The system of claim 35, further comprising computer program instructions to perform the step of:
logging in to a server containing an update.

37. The system of claim 36, wherein the logging in step comprises at least one of:
transmitting a username and password, filling and submitting an online form, accessing a cookie, and redirecting to another location.

38. The system of claim 37, wherein the standard protocol comprises hypertext transfer protocol or file transfer protocol.

39. The system of claim 38, wherein the information relating to the plurality of updates comprises at least one of a version, a creation date, a modification date, file sizes, and presence or absence of files.

40. The system of claim 38, wherein the information relating to the information to be updated and the information relating to the plurality of updates comprises script or data files including information indicating the information to be updated and the information relating to the plurality of updates.

41. The system of claim 38, wherein the initiating step comprises the step of:
periodically initiating an update.

42. The system of claim 38, wherein the initiating step comprises the step of:
initiating an update based on at least one predefined condition.

43. A computer program product for updating a plurality of anti-virus programs, comprising:
a computer readable medium;
computer program instructions, recorded on the computer readable medium, executable by a processor, for performing the steps of
initiating an update of a plurality of anti-virus programs;
determining information to be updated;
transferring a plurality of updates; and
installing the plurality of updates.

44. The computer program product of claim 43, wherein the initiating step comprises the step of:
periodically initiating an update.

45. The computer program product of claim 43, wherein the initiating step comprises the step of:
initiating an update based on at least one predefined condition.

46. The computer program product of claim 43, wherein the determining step comprises the step of:
determining information to update based on information relating to the information to be updated and on information relating to the plurality of updates.

47. The computer program product of claim 46, wherein the information relating to the information to be updated comprises at least one of a version, a creation date, a modification date, file sizes, and presence or absence of files.

48. The computer program product of claim 47, wherein the information relating to the plurality of updates comprises at least one of a version, a creation date, a modification date, file sizes, and presence or absence of files.

49. The computer program product of claim 46, wherein the information relating to the information to be updated and the information relating to the plurality of updates comprises script or data files including information indicating the information to be updated and the information relating to the plurality of updates.

50. The computer program product of claim 43, wherein the transferring step comprises the step of:
transferring the update using a standard, non-standard, or proprietary protocol.

51. The computer program product of claim 50, wherein the standard protocol comprises hypertext transfer protocol or file transfer protocol.

52. The computer program product of claim 43, wherein the installing step comprises at least one of:
decompressing a compressed update, decrypting an encrypted update, and copying a file included in an update to a directory.

53. The computer program product of claim 43, further comprising computer program instructions for performing the step of:
logging in to a server containing an update.

54. The computer program product of claim 53, wherein the logging in step comprises at least one of:
transmitting a username and password, filling and submitting an online form, accessing a cookie, and redirecting to another location.

55. The computer program product of claim 46, wherein the transferring step comprises the step of:
transferring the update using a standard, non-standard, or proprietary protocol.

56. The computer program product of claim 55, wherein the installing step comprises at least one of:
decompressing a compressed update, decrypting an encrypted update, and copying a file included in an update to a directory.

57. The computer program product of claim 56, further comprising computer program instructions for performing the step of:
logging in to a server containing an update.

58. The computer program product of claim 57, wherein the logging in step comprises at least one of:
transmitting a username and password, filling and submitting an online form, accessing a cookie, and redirecting to another location.

59. The computer program product of claim 58, wherein the standard protocol comprises hypertext transfer protocol or file transfer protocol.

60. The computer program product of claim 59, wherein the information relating to the plurality of updates comprises at least one of a version, a creation date, a modification date, file sizes, and presence or absence of files.

61. The computer program product of claim 59, wherein the information relating to the information to be updated and the information relating to the plurality of updates comprises script or data files including information indicating the information to be updated and the information relating to the plurality of updates.

62. The computer program product of claim 59, wherein the initiating step comprises the step of:
periodically initiating an update.

63. The computer program product of claim 59, wherein the initiating step comprises the step of:
initiating an update based on at least one predefined condition.
